(19) United States
(12) Patent Application Publication
(10) Pub. No.: US 2017/0242658 A1
(43) Pub. Date: Aug. 24, 2017

(54) SPECIALIZED DIGITAL ASSISTANTS FOR SCOPED NATURAL LANGUAGE OUTCOME FOCUSED OPTIONS

(71) Applicant: Microsoft Technology Licensing, LLC, Redmond, WA (US)

(72) Inventors: Bernhard S.J. KOHLMEIER, Seattle, WA (US); Christian BRAUN, Kirkland, WA (US); Rukmani GOPALAN, Redmond, WA (US); Pradeep CHILAKAMARRI, Seattle, WA (US)

(21) Appl. No.: 15/164,491

(22) Filed: May 25, 2016

Related U.S. Application Data
(60) Provisional application No. 62/299,532, filed on Feb. 24, 2016.

(51) Int. Cl. G06F 3/16; G06N 99/00; G06N 3/00; G06F 17/28; G06F 3/0481

(52) U.S. Cl. CPC G06F 3/167; G06F 17/28; G06F 3/04817; G06N 3/006; G06N 99/005

(57) ABSTRACT

Specialized digital assistants are described that provide scoped natural language, outcome focused options. Techniques and systems for generating the specialists are also provided so that the specialists can be embedded in or employed by other software applications. A specialist can be added directly to a website or application so that visitors to the website or application can more easily interact with the website or application and obtain desired outcomes. More than one specialist may be included in a website or application. The specialist is supported by a back-end specialized digital assistant service (“service platform”) that is scoped to the particular aspects of the website or application. The service platform can provide developer assistance by, upon receiving an indication that a specialized digital assistant component is being included in an application or a webpage, setting up a specialized digital assistant for that component.

### CROSS-REFERENCE TO RELATED APPLICATION(S)

This application claims the benefit of U.S. Provisional Application Ser. No. 62/299,532, filed Feb. 24, 2016.

### BACKGROUND

The human-machine interaction is moving from interactions in which a person commands a machine to perform specific tasks to a more machine-intelligent interaction that includes both proactive and reactive interactions. For example, a user may express an intent (e.g., “I want coffee”) that results in the machine presenting commands for tasks that relate to that intent (e.g., get directions to nearest coffee shop; search for sites to purchase coffee). The execution of a complex task could then be performed based on interactions that appear more natural to a person, as if the person is interacting with another person to achieve a desired intent. Today, applications in the form of personal digital assistants are included on various computing devices to provide a human-machine interaction interface.

Personal digital assistants include software that prompts a user to perform an action, provides suggestions, and performs certain tasks including providing information to the user. Today, personal digital assistants have become personalized digital assistants, such as GOOGLE NOW a registered trademark of Google Inc., SIRI a registered trademark of Apple ALEXA a registered trademark of Amazon.com, Inc., and CORTANA a registered trademark of Microsoft Corp. These assistants learn about a particular user and are able to interact with the user in a proactive manner by surfacing or verbalizing information that could be important to the user in some cases before the user specifically requests it. These assistants can further access the Internet and get answers to web or map searches.

### BRIEF SUMMARY

Specialized digital assistants (“specialists”) are described that provide scoped natural language, outcome focused options. Techniques and systems for generating the specialists are also provided so that the specialists can be embedded in or employed by other software applications.

A specialist can be added directly to a website or application so that visitors to the website or application can more easily interact with the website or application and obtain desired outcomes. More than one specialist may be included in a website or application. For example, in an email application, one specialist may be available from a main graphical user interface/window of the email application (e.g., where a mailbox view may be shown with a listing of email items) and another specialist may be available from a compose window (e.g., the graphical user interface that opens in response to receiving anew email command from the main window). The specialist for the main window can provide information and tools based on actions generally desired from the main window; whereas the specialist for the compose window can provide information and tools specifically scoped for content creation and composing of a message.

A specialist is supported by a back-end specialized digital assistant service (“service platform”) that is scoped to the particular aspects of the website or application. As a result, the website or web application developer or the individual or organization of the website can provide scoped natural language, outcome focused options without having a computer programming background. In one implementation, the developer or website creator can obtain, for a website or application development program, a software component that adds the specialist. For example, a plug-in, add on, or extension can be available for website and application creation tools or content management systems.

The specialist front end can be part of the web page/application and the specialist back end can be carried out by the service platform. The service platform includes a service layer and, for each specialist, an intent mapping processor that can include a classifier and a bag of words that the classifier uses to classify against a target and identify options.

The service platform can provide developer assistance by, upon receiving an indication that a specialized digital assistant component is being included in an application or a webpage, setting up a specialized digital assistant for that component. The set up involves initializing the specialized digital assistant component using received information comprising at least an initial set of outcome focused options corresponding to at least one target. The initialization can include forming an initial bag of words from the received information and training a classifier on the initial bag of words. The bag of words and classifier can form the back end of the specialized digital assistant and be assigned a unique identifier.

The service platform may also receive a target; classify the target; and provide at least one outcome focused option for the specialized digital assistant identified by the unique identifier. In some cases, additional information can be provided, for example, for promoting certain parts of the website, tools, functions, features, or content. Further, the service platform can receive an indication of a selected outcome focused option corresponding to the target; and update the bag of words using the selected outcome focused option corresponding to the target. Other analyses and processes can be carried out at the service platform.

The specialist front end can operate by receiving input, wherein the input is a target; sending the target to the service platform; receiving at least one outcome focused option; and providing for display the at least one outcome focused option. In one embodiment, the specialist may receive an indication of a selected outcome focused option (or lack of a selection); and send an indication of the selected outcome focused option (or the lack of a selection) to the service platform. In another embodiment, the specialist may receive an indication of a selected outcome focused option (or lack of a selection); and send an indication of the selected outcome focused option (or the lack of a selection) to the web page or application who collects the selected outcome focused options over a time frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example representation of a specialized digital assistant for scoped natural language outcome focused options.

FIG. 2A illustrates a process flow for generating a specialized digital assistant.

FIG. 2B illustrates a process flow of a generated specialized digital assistant.

FIG. 3 illustrates an operating environment in which various implementations of specialized digital assistants for scoped natural language outcome focused options may be carried out.

FIGS. 4A-4C illustrate example process flow diagrams for additional processes of a specialized digital assistant for scoped natural language outcome focused options.

FIGS. 5A-5B illustrate example scenarios for specialized digital assistants for scoped natural language outcome focused options.

FIG. 6 illustrates a block diagram of components of systems that may be used to implement the techniques described therein.

### DETAILED DESCRIPTION

Specialized digital assistants (“specialists”) are described that provide scoped natural language, outcome focused options. Techniques and systems for generating the specialized digital assistants are also provided so that the specialist can be embedded in or employed by other software applications.

While personal digital assistants continue to improve and include additional features and complexity, one of the challenges for these types of assistants is in productivity and other specialized applications. Current personal digital assistants tend to be general assistants that are not specialized in a particular productivity application or other specialized application. One reason why personal digital assistants tend to be general assistants is that the size of the file stored on a device could be prohibitive if the software includes programming to support, provide information, and suggest commands for all the possible programs that could be executed on that device. Instead, specialists may be used to support particular applications or tasks. For example, if a user would like assistance with a word processing or spread sheet-related task, a specialized assistant, such as available from a developer of the particular productivity application may provide assistance identifying a useful command or generating help information.

A specialist can be added directly to a website or application so that visitors to the website or application can more easily interact with the website or application and obtain desired outcomes. The specialist is supported by a back-end service platform that is scoped to the particular aspects of the website or application. As a result, the developer or the individual or organization of the website or application can provide scoped natural language, outcome focused options without having a computer programming background. In one implementation, the developer or website creator can obtain a software component that adds the specialist to the website development program. For example, a plug-in, add on, or extension can be available for WordPress or other website creation tool or website content management system. In another implementation, the specialist may be an embedded control included as a tool set when developing a webpage/website.

“Web page” refers to an HTML web page that is viewed using a web browser. As used herein, the term web page may also refer to a blog page. Where a blog is a specialized type of web page, typically maintained by an individual whose entries are commonly displayed in reverse-chronological order. A web page may include client-side scripting code in addition to HTML.

“Website” refers to a collection of static or dynamically generated web pages that are addressed with a common domain name in a network that uses Internet protocols. A web site is hosted on at least one web server which is a specialized type of server computer that serves web pages to a client computer running a web browser application. As used herein, the term website also refers to a blog site that provides bldg pages to a web browser.

“Application” refers to any computer program, or group of computer programs, that is designed to perform a group of coordinated functions, tasks, or activities for the benefit of the end user. Examples of applications include, but are not limited to, a word processor, a social media application such as Facebook, a media player, an email application, and mobile games such as Angry Birds.

A developer assistance platform is provided to assist with the development of specialized digital assistants and support the use of those specialized digital assistants. Through this platform, a developer of a website or application can include one or more specialists in the website or application so scoped natural language outcome focused options can be made available to users. Once a developer includes a specialist on a webpage or application, the platform can support the specialist and provide the back-end processing. With the specialist, the user does not have to learn what an application does (e.g., the specific commands available), but instead focus on the outcome. Through the specialist, a user can express themselves without knowing what is available to them in the application or web page. When a user is in the application or on the web page, the user can interact with a specialist front end using natural language. The platform can perform intent mapping to provide the best possible learned information and functionality.

The specialists enable a user of the website or application to indicate a desired outcome and receive options scoped for the particular website or application. The options are considered “scoped” because they are highly tuned to the particular website or application (or even just a part of the website or application). The options can be a form/template, action, or function (e.g., command). The options available in response to receiving certain user inputs (e.g., associated with a phrase, key word, topic, etc.) can be initially set up by the developer during the onboarding process to the developer assistance platform. Over time, actual usage data may be used to tune the classifier. Of course, the developer can include additional options (or weighted options) so that developer-requested options are made available to the user.

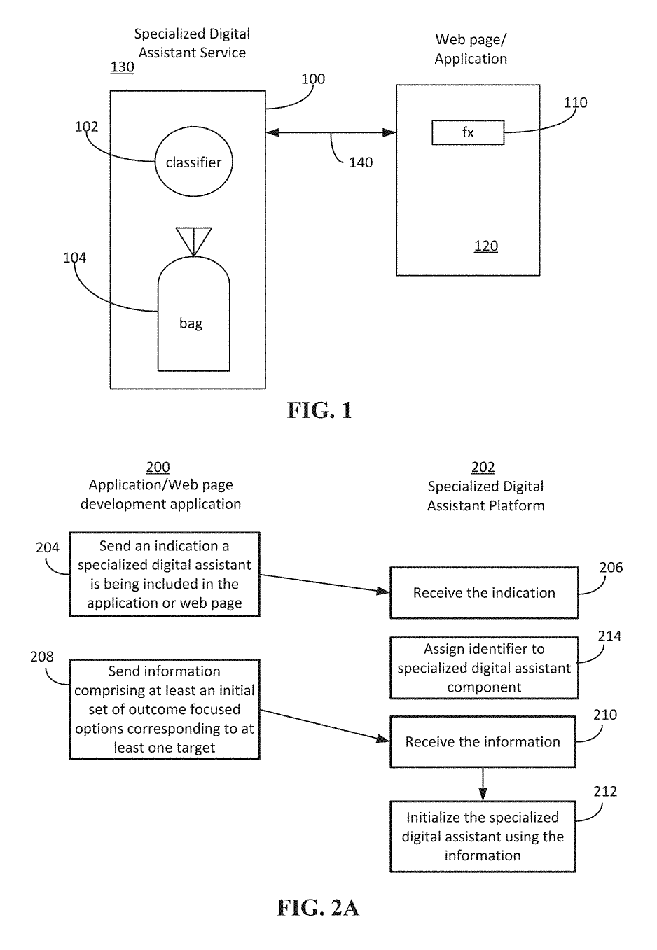

FIG. 1 illustrates an example representation of a specialized digital assistant for scoped natural language outcome focused options. Referring to FIG. 1, a specialized digital assistant can include a back end 100 that takes in an input (the “target”) and determines a result. The back end 100 provides an intent mapping processor and can include a classifier 102 and a “bag of words” 104, as well as a slot filler for parameter intents. The bag of words 104 refers to a set of words used to train the classifier 102 so that the back end 100 can perform intent mapping to identify, from a target, one or more options that can be relevant as a result. In some cases, a state machine may be used in place of a classifier. The slot filler may be used to extract information and even relationships for classifying and/or identifying outcome focused intents,

In addition to the back end 100, the specialized digital assistant includes a front end 110. The front end 110 is an embedded control that can be imbedded in a webpage or application 120. The front end 110 enables communication between the web page/application 120 and the back end 100 so that interactions by a user at the webpage or application 120 can be communicated to the back end 100 to perform the intent mapping. As described, the specialist involves an embedded component (front end 110) and a processing component (back end 100). The back end 100 can be implemented by a specialized digital assistant service 130, Which provides a developer assistance platform to assist with the development and support of specialists. The specialized digital assistant service 130 and the web page/application 120 may be executed by processing systems of different devices and communicate over a network 140.

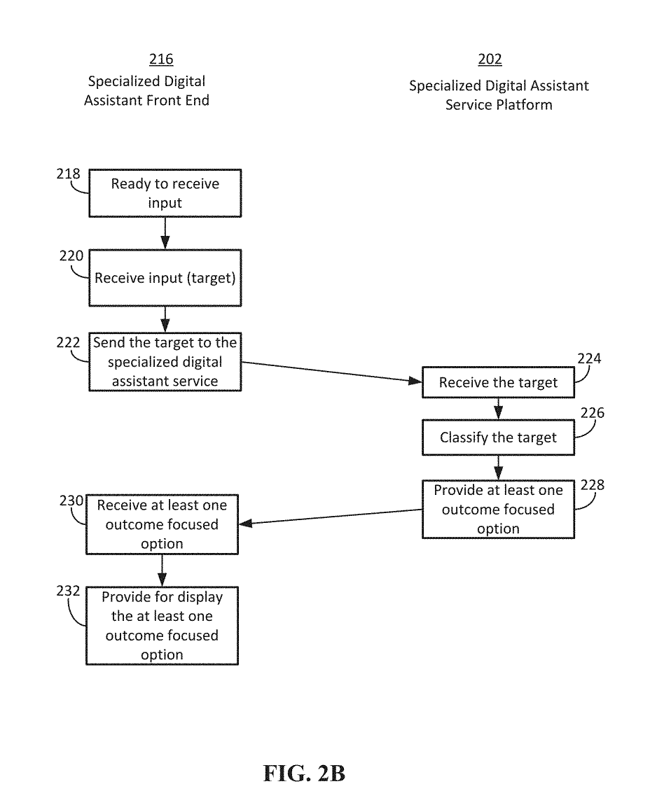

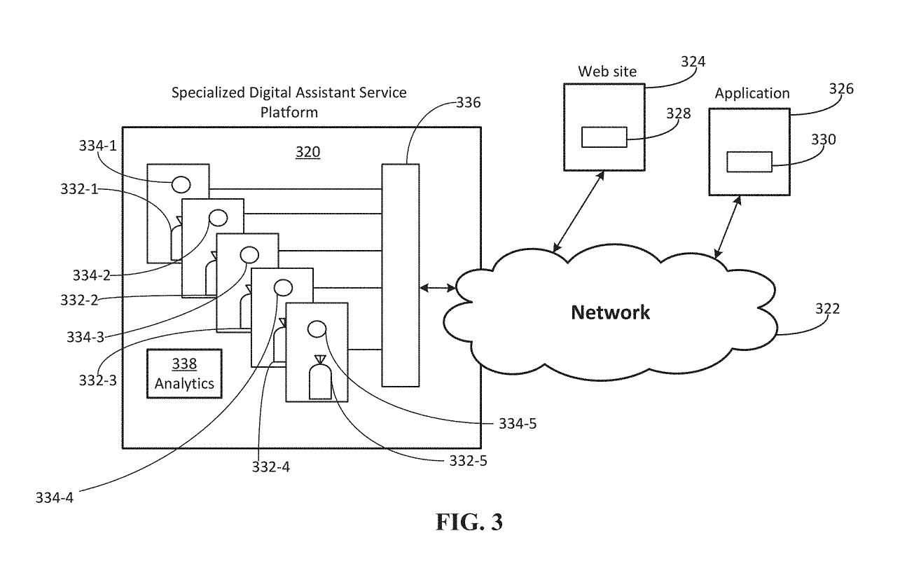

FIG. 2A illustrates a process flow for generating a specialized digital assistant. In the example process flow of FIG. 2A, communication between a development application 200 and a specialized digital assistant platform 202 (providing the development assistance and which may also provide the specialized digital assistant service) is shown. A website or application developer can be using any software application 200 that enables the development of a website or application. For example, a website may be developed using WordPress and the specialized digital assistant can be a plug-in for a bldg or website created using WordPress. By indicating the inclusion of the specialist “plug-in”, a wizard or other user interface can appear to facilitate communication with the specialized digital assistant service platform 202 (acting as a developer assistance platform).

Referring to FIG. 2A, the process flow may begin when a development application 200 sends an indication to the service platform 202 that a specialist (a specialized digital assistant component) is being included in an application or web page (204). In one implementation, more than one specialist may be included in the application or web page. For example, for a website of a company, one specialist can be trained on intents and actions of visitors on a sales page of the company site and another specialist can be trained on intents and actions of visitors on an information page of employees and management of the company.

The service platform 202 can receive the indication that a specialist is being included in an application or website (206). In one implementation, the communication can be a result of a developer/creator executing a software component that adds a specialized digital assistant component to the content in the development program. For example, a plug-in, add on, or extension can be available for the development program. In another implementation the specialist may be an available embedded control tool that is included as a tool set in the development application 200.

To establish a particular specialist (since more than one specialist may be included for a website or application), an onboarding process can be carried out. Information to create the specialist is sent from the development application 200 to the service platform 202 (208). This information can include at least an initial set of outcome focused options corresponding to at least one target. Content, phrases, and other information can be included.

The service platform 202 receives this information (210), and uses the information to initialize the specialist (212). As part of the initialization process, the service platform uses the information concerning pages of the application/website, available responses, and other similar information to support the intent mapping of input received from the specialist front end. This initialization can include creating a bag of words and training a classifier. Data about actual usage can be fed back and used to update the bag of words, possible intents, available options, and the like. For example, the initialization of the specialist may be accomplished by forming an initial bag of words with the one or more initial sets of outcome focused options. In some cases, pages of a website are fed into the bag of words. Once the initial bag of words is formed, the classifier may then be trained on the initial bag of words.

Each specialized digital assistant component can be assigned an identifier (214). This may be carried out upon receiving the indication that a specialized digital assistant is being included in the application or web page. In some cases, the communication indicating the specialized digital assistant is being included in the application or web page includes the identifier.

With the establishment of a specialized digital assistant component, a bridge can be built between site (or app) and service platform. The developer, as part the onboarding process, may select to allow for communication between the application web page and service platform. This bridge can be similar to the currently available search embed functions (that let developers include an easy search tool on their site). The bridge supports the sharing of data. Data about a user's interaction with the site or application can be, with permission, shared with the service platform 202. It should be understood, of course, that confidential or private information would not be shared without explicit consent of a user and that such information is not necessary or required for use. Data about user's interactions that are to be sent to the service platform 202 do not require information about the user, instead, the data used by the service platform 202 includes the commands and/or activity history of the users. This history information can include both the actions taken with respect to the embedded specialist as well as interactions with other things on the page. Once initialized, the specialist can be ready to function.

FIG. 2B illustrates a process flow of a generated specialized digital assistant. The processes illustrated in FIG. 213 can begin after the initialization of operation 212 is complete. Referring to FIG. 2B, with the publishing of a website or application a specialist (via specialized digital assistant front end 216) may be ready to receive input (218). Input can be received via the specialized digital assistant front end 216 (220). In various implementations, the input may be, but is not limited to, typed input, handwritten input, audio data/voice input, or touch screen input, The input, a natural language expression of intent, is considered the target of the scoped options. Some processing may be carried out at the front end 216 to analyze or simply format the input for communicating to the service platform 202 and the input, as a target, is sent to the service platform 202 with the appropriate specialist identifier (222).

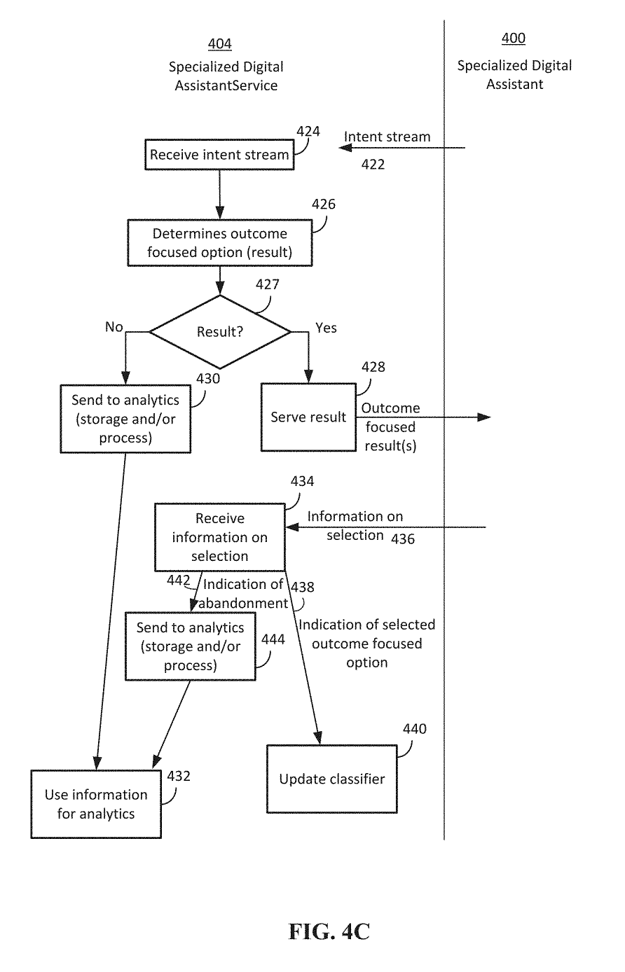

The service platform may then receive the target (and identifier) (224), and classify the target to identify at least one outcome focused option (226). A slot filler evaluation can be performed as part of or during the classifying step (operation 226). At the service platform, the identifier can enable the service to use the appropriate classifier when classifying the target. In some cases, the service is not able to identify a suitable option (or suitably classify the target). This information can be used by an analytics feature of the service to improve the specialist and provide insights to the developer/owner of the website/application. An example process flow is shown in FIG. 4C. Upon identifying one or more outcome focused options, the service platform may provide at least one outcome focused option to the application or website (228).

The specialist can then receive the at least one outcome focused option from the service platform (230) and provide for display the least one outcome focused option (232). In some cases, the specialist will receive a list of outcome focused options. The outcome focused options can be a form/template, action, or function, The user will be able to choose from the list of outcome focused options and the specialist will direct them to the appropriate information. In some cases, no listing of outcome focused options is presented, instead a template/form is provided or an action can occur. For example, the specialist (or the application or webpage) will start playing a video or display a sign-up form.

In some cases, the software instructions of a front end of a specialized digital assistant component can enable a system to communicate with the specialized digital assistant service to provide an indication that the specialized digital assistant component is being included in an application or a webpage; and communicate with the specialized digital assistant service to provide information comprising at least an initial set of outcome focused options corresponding to at least one target that is expected to be received via the graphical user interface for the front end of the specialized digital assistant component. A graphical user interface can be provided for the front end of the specialized digital assistant component so that users of the webpage or application can access the functionality of the specialized digital assistant. In response to receiving a user input via the graphical user interface of the front end of the specialized digital assistant component, the front end of the specialized digital assistant component can communicate the user input as a target to the specialized digital assistant service along with an identifier of the specialized digital assistant component (the specialist identifier); receive at least one outcome focused option from the specialized digital assistant service; and provide for display one or more of the at least one outcome focused options.

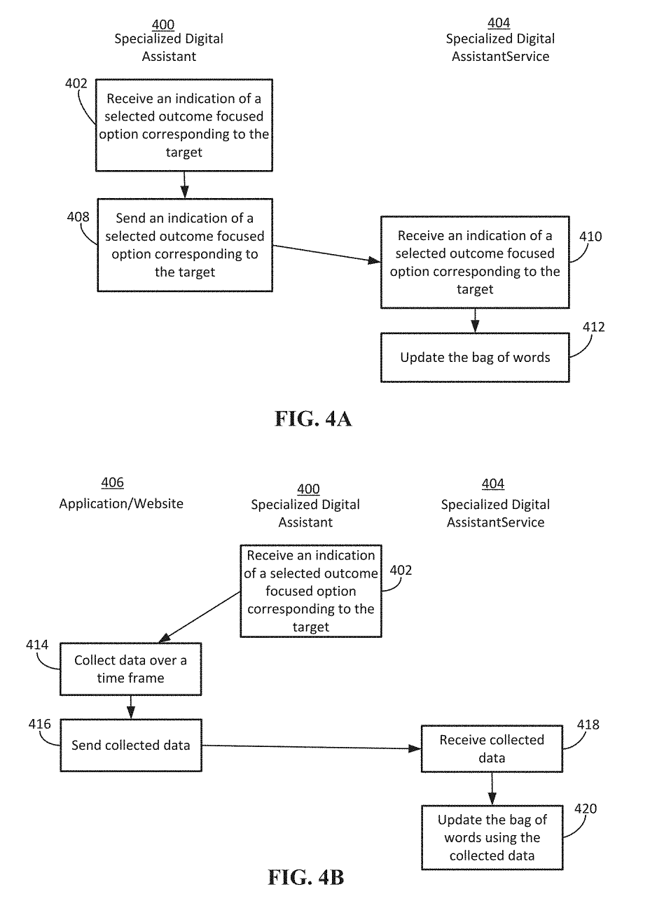

FIG. 3 illustrates an operating environment in which various implementations of specialized digital assistants for scoped natural language outcome focused options may be carried out. As illustrated in FIG. 3, the specialized digital assistant service can support a plurality of specialists (with corresponding back and front ends), as well as provide analytics software for a variety of analytics features.

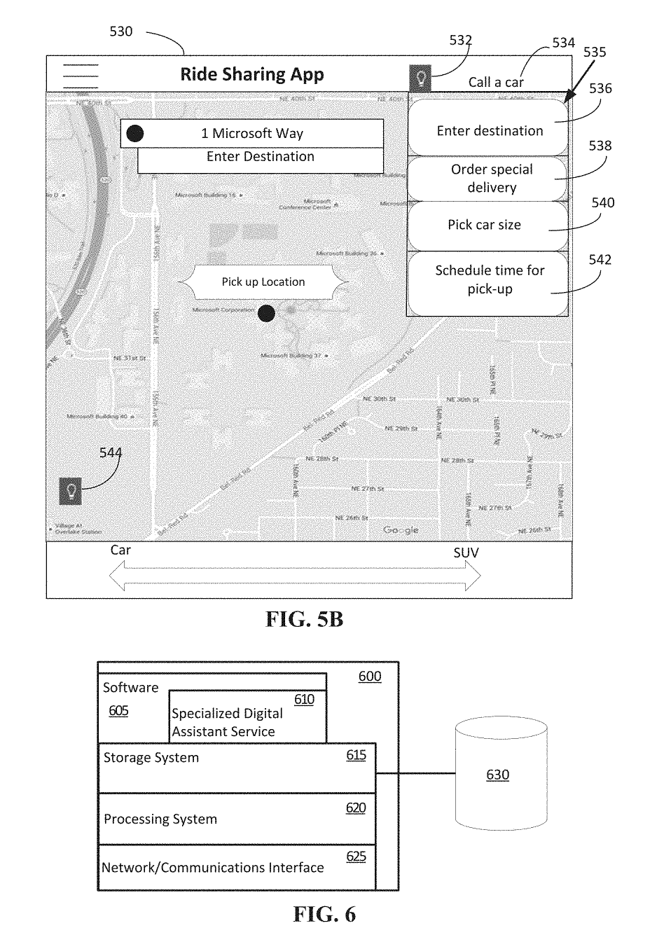

Referring to FIG. 3, an example operating environment can include a service platform 320 supporting a plurality of specialists for a plurality of websites such as website 324 with specialist front end 328 and a plurality of applications such as application 326 with specialist front end 330. The specialists function through communication over network 322. Service platform 320 may be embodied as computing system 600 such as described with respect to FIG. 6.

The network 322 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 322 may include one or more connected networks (e.g., a multi-network environment) including public networks, such as the Internet, and/or private networks such as a secure enterprise private network. Access to the network 322 may be provided via one or more wired or wireless access networks as will be understood by those skilled in the art.

Through the service platform 320, specialists can be added to any website (or other Internet-accessible location with content and executable code) or application. More than one specialist can be included for a website or application. The service platform 320 includes a service layer 336 and a specialist back end for each specialist front end. For example, classifiers 334-1, 334-2, 334-3, 334-4, 334-5 trained on specialist-specific bags of words 332-1, 332-2, 332-3, 332-4, 332-5 can be provided for each specialist front end (and identified by an identifier assigned to the specialist).

In one example implementation, during operation of a specialist, a specialist front end (e.g., 328) communicates with service 336, via an application programming interface (API). That is, the service layer 336 may be implemented as a programming function which may be accessible or “callable” through an API. Service platform 320 can further include an analytics component 338 (e.g., software providing the various analytics features). The analytics component 338 can be accessed, for example, through a graphical user interface to the service platform 320 or made available through APIs, to provide insights on usage of particular specialist (for the owner/developer of the website/application).

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

An API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic.

The API-calling component may be a local component (i.e., on the same data processing system as the API-implementing component) or a remote component (i.e., on a different data processing system from the API-implementing component) that communicates with the API-implementing component through the API over a network.

It should be understood that an API-implementing component may also act as an API-calling component (i.e., it may make API calls to an API exposed by a different API-implementing component) and an API-calling component may also act as an API-implementing component by implementing an API that is exposed to a different API-calling component. The API and related components may be stored in one or more machine-readable storage media (e.g., storage media such as hard drives, magnetic disks, solid state drives, random access memory. flash, CDs, DVDs and the like).

Thus, when specialist front end 328 communicates a target to service 336, service 336 can identify the appropriate classifier (e.g., 334-1) and use the classifier to identify the scoped outcomes corresponding to the target.

Data (including targets and selected outcomes) from the applications and webpages having the specialist front ends may be directed to the appropriate classifier 334-1, 334-2, 334-3, 334-4, 334-5 and bag of words 332-1, 332-2, 332-3, 332-4, 332-5 through the service layer 336. The service layer 336 may also be used to communicate these input streams to the analytic component 338. The service layer 336 may receive the outcome focused options and send them to the specialist 328, 330 included in the web page 324 and the application 326 for display.

The specialist front ends (e.g., 328, 330) can be embedded components in their corresponding web page (e.g., 324) or application (e.g., 326). The embedded components within the web page 324 or application 326 may have a smart implementation, a “dumb” implementation, a combination of smart and dumb implantations. The smart implementation includes an embedded component with at least a cache. The smart implementation can also have or can communicate with other services for, but not limited to, work wheeling, spelling corrections, translation, handwriting recognition, voice to text. For example, the smart embedded may first send the inputted intent data to Google® Translate before sending it to the service layer 336 in the service platform 320.

The dumb embedded component is included in the web page 324 or application 326 to help keep a feedback loop going as well as provide functionality so the developer does not need to program. The dumb embedded component sends and receives data to and from the service layer 336 in the service platform 320 without providing additional functionality at the webpage or application.

FIGS. 4A-4C illustrate example process flow diagrams for additional processes of a specialized digital assistant for scoped natural language outcome focused options.

Referring to FIGS. 4A and 4B, once the at least one outcome focused option is received (230) and the specialist/application/website provides for display the least one outcome focused option (232) such as described with respect to FIG. 2, the specialist front end 400 may receive an indication of a selected outcome focused option corresponding to the target (402). Usage data can be collected (with permission) directly by the service platform 404 (as shown in FIG. 4A) or first by the application or website 406 (as shown in FIG. 4B). It should be understood that usage data does not require personal information and any information considered to be personal or private would be expected to be expressly permitted by the user before such information was stored or used.

Referring to FIG. 4A, responsive to receiving the indication of a selected outcome focused option corresponding to the target, the specialist front end 400 can send an indication of the selected outcome focused option corresponding to the target to the service platform 404 (408).

The service platform 404 can receive the indication of the selected outcome focused option corresponding to the target (41.0), and, in some cases, store the information. The service platform 404 is then able to update the bag of words using the selected outcome focused option corresponding to the target (412). The updated bag of words is used to train the classifier (as a machine learning operation). Training can be carried out over time by identifying what visitors to a website or users of an application do in certain scenarios after making a query. In addition, this data, or usage data, can be used for further fine tuning the outcome focused options. For example, an application can receive a query(i.e. target) from a high number of people for “an answer” or this query may be trending (e.g., increasing numbers of requests). The developer might not know what this query is about; however, the logs can indicate the numbers of this request and what actions were done after the query was made and so the service platform can identify the likely desired actions based on that particular search query identify the ultimate intent). The usage data can be analyzed by the analytics component of the service to accomplish the above described analysis of metrics, trends, and the like.

Referring to FIG. 4B, responsive to receiving the indication of a selected outcome focused option corresponding to the target, the application/website 406 can collect data over a time frame (414). The collected data may be referred to as usage data. The application/web page server 406 may collect the information about selected outcome focused option corresponding to the targets/intents as well as other activity user performs with respect to the application/webpage. Analysis of the data can be carried out at the service. In addition, the collected data can be used for training the classifier. The more training that may be completed on the classifier, the more scoped/focused the outcome focused options will be. For example, an application can receive a natural language query (providing the target) from a high number of people for “an answer” or this query may be trending (e.g., increasing numbers of requests). The developer might not know what this query is about; however, the logs can indicate the numbers of this request and what actions were done after the query was made and so the service platform can identify the likely desired actions based on that particular search query (to identify the ultimate intent).

Subsequent to the collection of the data, the application/web page server 406 may send the collected data to the service platform 404 (416). In one embodiment, the data may be collected by the site host of a web page over a time frame and provided to the service when requested by the service or at certain times. In another embodiment, usage data may be collected by the site host of the web page over a time frame and provided to the service periodically. It should be understood that usage data does not require personal information and any information considered to be personal or private would be expected to be expressly permitted by the user before such information was stored or used.

The service platform may receive the collected data from the application/web page (418) so that the service platform can then update the bag of words using the collected data (420). The updated bag of words is then used to train the classifier in order to obtain more highly tuned outcome focused options.

Referring to FIG. 4C, which illustrates processes for collecting the data for analytics, an input stream can be processed for analytics at multiple points during the specialist behavior. Through collection of the data, the service can facilitate analytics and automatic classifier training and manipulation of the classifier to steer the user to a certain target.

One point of data collection can be at the initial receipt of a target from a specialized digital assistant 400. These target inputs (and other data) can be considered a stream of intents 422. The specialized digital assistant service 404 can receive (424) the intent stream 422 (e.g., the data providing the target) such as described with respect to operation 224 in FIG. 29. The received intent stream (with target) is processed (426) to determine whether there is at least one outcome focused option, such as described with respect to operation 226 of FIG. 2B. However, sometimes there is no suitable result. For example, because the determined intent does not have a corresponding feature available from the webpage or application or because the specialist has not yet connected the target to the outcome (but could via machine learning). Accordingly, as shown in FIG. 4C, when the specialist back end at the service performs the processes (426) to determine the outcome focused option (result), a determination (427) can be made as to whether there is a result to serve back to the specialist front end. If there is a result, the result of one or more outcome focused options can be provided (428) to the specialist front end, such as described with respect to FIG. 2B. there is no result, that information can be stored (430) for later analysis (e.g., use by analytics component 432).

Another point of data collection can occur upon receipt 434 of information 436 on whether one of the outcome focused options provided to the user based on their input was selected. This information can be collected, for example, as described with respect to FIGS. 4A and 4B. In a case that the information 436 indicates a selection of the outcome focused option 438, the information indicating a selected outcome focused option can be used to update the classifier (440). In a case that the information 436 indicates that no outcome focused option is selected 442, at least information of the target (from the intent stream) can be stored (444) and used during analytics (432).

Accordingly, the information about intents that could not be served along with the feedback data from whether the user selected to use one (or more) of the outcome focused options that were provided in response to the request via the specialist can be stored and provided or otherwise accessed by the analytics feature in order to perform analytics 432 (e.g., with analytics component 338 of FIG. 3). The analytics can include any suitable tools for generating metrics and/or identifying patterns in the data. It should be understood that although this specific implementation focuses on analytics of cases where a target is not able to be classified or results are not used, analysis can be carried out to generate metrics and other analytics on targets that are served (and their resulting selected options).

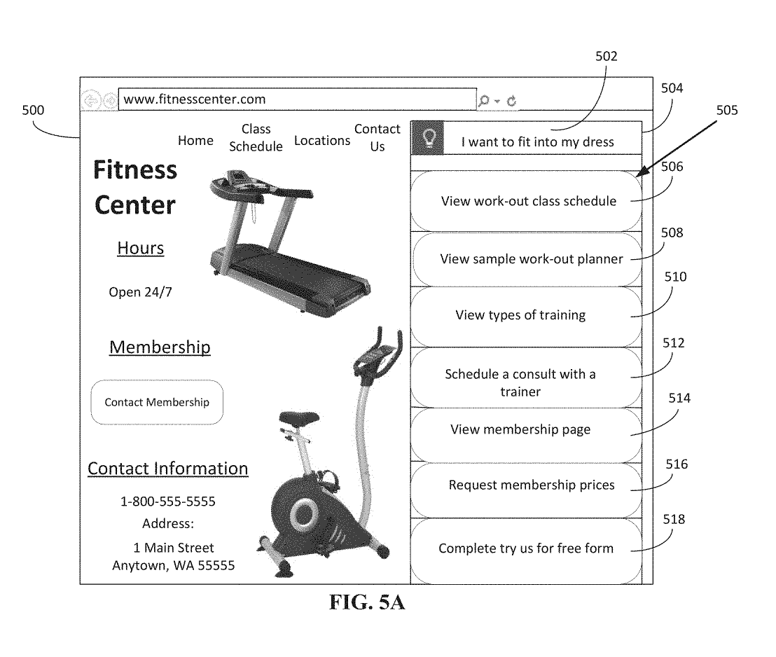

FIGS. 5A-5B illustrate example scenarios for specialists for scoped natural language outcome focused options.

Referring to Figure SA, a developer for a fitness center website 500 can include a specialized digital assistant component in their website 500 so if a visitor enters a desired outcome (or target) 502 via a user interface 504 to the specialized digital assistant component (the front end), the specialized digital assistant (“specialist”) can, through communication with the service platform, provide scoped options. In this example, the scoped options are provided in the form of a list 505. The list 505 can direct the user to a particular option. Instead of taking time to learn the content of the fitness center's website 500, a visitor uses the digital assistant interface 504 to input a natural language statement of intent 502. The statement 502 represents the visitor's desired outcome, in this example “I want to fit into my dress”. Other examples could be to “lose weight” or “gain muscle”.

The visitor's statement 504 returns a list 505 of highly tuned options that include what the visitor could do on the fitness center's website 500 that would help achieve their desired outcome. In some cases, a list 505 of options may include an option that directs the user to a form or template for the user to fill out. An example of this option may include the specialist bringing up a spreadsheet for budgeting a wedding. In other cases, a list of options may include an option that directs the website to perform an action, such as play a video or song. In yet another example, a list of options may include an option that directs the website to perform a function, such as calculate average cost of weddings in the area. In some cases, no listing of options is presented, instead a template or form is provided or an action can occur.

The example options shown include view work-out class schedule 506, view sample workout planner 508, view types of training 510, schedule a consult with a trainer 512, view membership page 514, request membership prices 516, or complete a form 518. The visitor can then choose one of the options 506, 508, 510 . . . , 518 and be directed to the correct location in the website 500 or the site may surface the appropriate item.

Referring to Figure SB, the developer for a ride sharing application 530 can include a specialist with a front end interface 532 so if a user enters a desired outcome, the specialist can direct the user to a particular option. Examples of popular ride sharing applications include LYFT, a registered trademark of Lyft, Inc. and UBER, a registered trademark of Uber Technologies, Inc. Specific options can be made available, based on the options provided by the developer during set up of the specialist. Examples of functionality/options include helping a user to quickly launch the application 530, even if they are in a crowded or noisy environment, and effectively and intuitively produce their desired outcome and have it transacted immediately. For example, the addition of the specialist interface 532 removes the need for multiple steps and clicking through numerous buttons. Further, the specialist also allows the user to save the time it would take to learn how to use and navigate through the application 530.

A user of the ride sharing application 530 may use the specialist interface 532 to input a natural language statement 534. The statement 534 represents the user's desired outcome, in this example “Call a car”. As further examples, the user's statement 534 could indicate a desired outcome of “schedule pickup at a certain time” or “schedule an SUV for pickup at a certain time to a certain destination”. In one embodiment, the developer may set up the specialist to recognize the top five intents, or targets, from the users of the ride sharing application 530. This will allow the developer to ensure that if a user inputs an intent or desired outcome from the top five list, no matter how that input is stated, it will not be missed by the application 530 and the specialist.

The visitor's statement 534 may return highly tuned options that may, in some cases include a list 535 of options that the user could perform on the ride sharing application 530 that would help achieve their desired outcome, The illustrated options for this example include enter destination 536, order special delivery 538, pick car size 540, and schedule time for pick up 542. The user can then choose one of the options 536, 538, 540, 542 and it can be transacted immediately.

A second specialist (and corresponding front-end with interface 544) could be included in this application, for example, in a map within the ride sharing application 530. This specialist could provide scoped outcomes particular to that page, for example, to allow the user to search for specific places within the map, which may further be used to select a pick up location or schedule a ride.

FIG. 6 illustrates a block diagram of a computing system that may implement the service platform described herein. Referring to FIG. 6, system 600 may be implemented within a single computing device or distributed across multiple computing devices or sub-systems that cooperate in executing program instructions. The system 600 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 600 can include a processing system 620, which may include one or more processors and/or other circuitry that retrieves and executes software 605 from storage system 615. Processing system 620 may be implemented within a single processing device but may also be distributed across multiple processing devices or sub-systems that cooperate in executing program instructions.

Examples of processing system 620 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system(s) 615 can include any computer readable storage media readable by processing system 620 and capable of storing software 605. Storage system 665 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a propagated signal or carrier wave.

In addition to storage media, in some implementations, storage system 615 may also include communication media over which software may be communicated internally or externally. Storage system 615 may be implemented as a single storage device but may also be implemented across multiple storage devices or sub-systems co-located or distributed relative to each other. Storage system 615 may include additional elements, such as a controller, capable of communicating with processing system 620.

In some cases, storage system 615 includes data for a specialist 630. in other cases, the data for the specialist 630 is part of a separate system with which system 600 communicates, such as a remote storage provider. For example, data, such as user input or a selected outcome focused option, may be stored on any number of remote storage platforms that may be accessed by the system 600 over communication networks via the communications interface 625. Such remote storage providers might include, for example, a server computer in a distributed computing network, such as the Internet. They may also include “cloud storage providers” whose data and functionality are accessible to applications through OS functions or APIs.

Software 605 may be implemented in program instructions and among other functions may, when executed by system 600 in general or processing system 620 in particular, direct the system 600 or processing system 620 to operate as described herein for generating and supporting a specialized digital assistant for scoped natural language outcome focused options (with service 610).

Software 605 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 6, can be thought of as additional, nested groupings within the operating system space, each containing an OS, application programs, and APIs.

Software 605 may also include firmware or some other form of machine-readable processing instructions executable by processing system 620.

System 600 may represent any computing system on which software 605, including the specialized digital service 610, may be staged and from where software 605 may be distributed, transported, downloaded, or otherwise provided to yet another computing system for deployment and execution, or vet additional distribution.

In embodiments where the system 600 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 625 may be included, providing communication connections and devices that allow for communication between system 600 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface can be controlled by the OS, which informs applications of communications events when necessary.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

By way of example, and not limitation, computer-readable storage media may include volatile and non-volatile, removable and non-removable media implemented in any method or technology for storage of information such as computer-readable instructions, data structures, program modules or other data. Examples of computer-readable storage media include volatile memory such as random access memories (RAM, DRAM, SRAM); non-volatile memory such as flash memory, various read-only-memories (ROM, PROM. EPROM, EEPROM), phase change memory, magnetic and ferromagnetic/ferroelectric memories (MRAM, FeRAM), and magnetic and optical storage devices (hard drives, magnetic tape. CDs, DVDs). As used herein, in no case does the term “storage media” consist of carrier waves or propagating signals.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of generating and supporting a specialized digital assistant for scoped natural language outcome focused options, the method comprising:
receiving an indication that a specialized digital assistant component is being included in an application or a webpage;
assigning an identifier for the specialized digital assistant component;
receiving information comprising at least an initial set of outcome focused options corresponding to at least one target that is expected to be received via a front end of the specialized digital assistant component at the application or the webpage; and
initializing the specialized digital assistant component using at least the initial set of outcome focused options.

2. The method of claim 1, wherein initializing the specialized digital assistant component comprises forming an initial bag of words and training a classifier on the initial bag of words.

3. The method of claim 1. further comprising:
receiving a target and the identifier from the front end of the specialized digital assistant component;
identifying the specialized digital assistant component from the identifier;
using the specialized digital assistant component to map the target to one or more outcome focused options; and
providing at least one outcome focused option to the front end of the specialized digital assistant component.

4. The method of claim 3, further comprising:
receiving, from the front end of the specialized digital assistant component, information indicating whether one of the at least one outcome focused option has been selected.

5. The method of claim 3, wherein in a case that the target cannot be mapped to one or more outcome focused options, store information of the target for analytics.

6. The method of claim 1, wherein the receiving information comprising the at least the initial set of outcome focused options corresponding to the at least one target further comprises receiving the information at a time of establishing the specialized digital assistant component.

7. The method of claim 1, Wherein the receiving information comprising the at least the initial set of outcome focused options corresponding to the at least one target further comprises accessing the user input and the resulting following action by user.

8. A specialized digital assistant platform comprising:
a processing system;
a storage system; and
a specialized digital assistant service stored on the storage system that, When executed by the processing system, directs the processing system to:
receive an indication that a specialized digital assistant component s being included in an application or a webpage;
assign an identifier for the specialized digital assistant component;
receive information comprising at least an initial set of outcome focused options corresponding to at least one target that is expected to be received via a front end of the specialized digital assistant component at the application or the webpage; and
initialize the specialized digital assistant component using at least the initial set of outcome focused options.

9. The platform of claim 8, wherein the specialized digital assistant service directs the processing system to initialize the specialized digital assistant component by at least forming an initial bag of words and training a classifier on the initial bag of words.

10. The platform of claim 8, wherein the specialized digital assistant service directs the processing system to:
receive a target and the identifier from the front end of the specialized digital assistant component;
identify the specialized digital assistant component from the identifier;
use the specialized digital assistant component to map the target to one or more outcome focused options; and
provide at least one outcome focused option to the front end of the specialized digital assistant component.

11. The platform of claim 10, wherein the specialized digital assistant service further directs the processing system to:
receive, from the front end of the specialized digital assistant component, information indicating whether one of the at least one outcome focused option has been selected; and
in a case that the information indicates a selection of the outcome focused option use the information indicating a selected outcome focused option to update the classifier;
in a case that the information indicates that no outcome focused option is selected, store at least information of the target for analytics.

12. The platform of claim 10, wherein in a case that the target cannot be mapped to one or more outcome focused options, store information of the target for analytics.

13. The platform of claim 8, wherein the specialized digital assistant service directs the processing system to receive the information comprising the at least the initial set of outcome focused options corresponding to the at least one target by at least receiving the information at a time of establishing the specialized digital assistant component.

14. The platform of claim 8. wherein the specialized digital assistant service directs the processing system to receive the information comprising the at least the initial set of outcome focused options corresponding to the at least one target by at least accessing the user input and the resulting following action by user.

15. One or more computer readable storage media having instructions stored thereon that when executed by a processing system, direct the processing system to:
provide a graphical user interface of a front end of a specialized digital assistant component;
communicate with a specialized digital assistant service to provide an indication that the specialized digital assistant component is being included in an application or a webpage; and
communicate with the specialized digital assistant service to provide information comprising at least an initial set of outcome focused options corresponding to at least one target that is expected to be received via the graphical user interface for the front end of the specialized digital assistant component.

16. The media of claim 15, further comprising instructions that, when executed by the processing system, direct the processing system to:
in response to receiving a user input via the graphical user interface of the front end of the specialized digital assistant component, communicate the user input as a target to the specialized digital assistant service along with an identifier of the specialized digital assistant component; receive at least one outcome focused option from the specialized digital assistant service; and provide for display one or more of the at least one outcome focused options.

17. The media of claim 16, further comprising instructions that, when executed by the processing system, direct the processing system to:
in response to receiving a selection of one of the one or more of the at least one outcome focused options provided for display, communicating an indication of the selection to the specialized digital assistant service.

18. The media of claim 15. wherein the front end of the specialized digital assistant component comprises an embedded control, a plug-in, an add on, or an extension to the web page or the application.

19. The media of claim 15, wherein the instructions that direct the processing system to communicate with the specialized digital assistant service to provide the information comprising the at least the initial set of outcome focused options corresponding to the at least one target that is expected to be received via the graphical user interface for the front end of the specialized digital assistant component, direct the processing system to at least communicate the information at a time of establishing the specialized digital assistant component after providing the indication that the specialized digital assistant component is being included in the application or the webpage.

20. The media of claim 15, wherein the instructions that direct the processing system to communicate with the specialized digital assistant service to provide the information comprising the at least the initial set of outcome focused options corresponding to the at least one target that is expected to be received via the graphical user interface for the front end of the specialized digital assistant component, direct the processing system to at least communicate, for a time frame, user input received via the graphical user interface of the front end of the specialized digital assistant component and resulting following actions by user.
